(19) United States
(12) Patent Application Publication
(10) Pub. No.: US 2013/0209974 A1
(43) Pub. Date: Aug. 15, 2013

(54) Exemplar Descriptions of Homophones to Assist Visually Impaired Users

(71) Applicants: Karan Misra, Mountain View, CA (US); Brent Douglas Ramerth, San Francisco, CA (US)

(72) Inventors: Karan Misra, Mountain View, CA (US); Brent Douglas Ramerth, San Francisco, CA (US)

(73) Assignee: APPLE INC., Cupertino, CA (US)

(21) Appl. No.: 13/397,239

(22) Filed: Feb. 15, 2012

(51) Int. Cl. G09B 1/00

(52) U.S. Cl. 434/167

(57) ABSTRACT

The disclosed implementations provide systems, methods and computer program products that provide computer accessibility for visually impaired users by audibly presenting exemplary descriptions of homophones. Commonly used characters can be described by using a common multi-character word that includes the character. Rarely used characters can be described using an Ideographic Description Sequence (IDS) that splits characters into individual components. Each component can then be read aloud individually as a description of the homophone character.

### TECHNICAL FIELD

This disclosure relates generally to accessibility solutions for electronic devices.

### BACKGROUND

The Chinese and Japanese languages present a unique challenge with regard to devising an accessibility solution for visually impaired users because, unlike English, one cannot “spell” Chinese characters to distinguish among homophones. A homophone is a character or group of characters that are pronounced the same as another character or group. For example, in English the words “rain” and “reign” are homophonous and can be distinguished only by spelling out the words. In Chinese, words can be made of several Chinese characters that are homophones. The only way to distinguish these words from one another is by seeing the characters, which is not an option for visually impaired users.

### SUMMARY

The disclosed implementations provide systems, methods and computer program products that provide computer accessibility for visually impaired users by audibly presenting exemplary descriptions of homophones.

In some implementations, a given character can be described by using a common multi-character word that includes the character. For example, the Chinese character [symbol] (rain) has the pronunciation y\check{u}, but other Chinese characters like [symbol] (language), [symbol] (feather) and [symbol] (universe) share the same pronunciation. To describe [symbol] (rain) uniquely the disclosed system and methods construct an “exemplar description,” such as “ [symbol] ,” which when translated to English would say “y\check{u}” as in “falling rain.” This method works well for describing commonly used Chinese characters (e.g., there are about 3,000-4,000 such Chinese characters) which occur as part of longer words.

In some implementations, rarely used characters can also be described. For example, [symbol] is a Chinese character that many native Chinese or Japanese speakers would rarely encounter since it is not used in modern Chinese or Japanese language. To describe a rare Chinese or Japanese character, an Ideographic Description Sequence (IDS) can be used to split the character into its components. For example, the Chinese character [symbol] can be split into two characters [symbol] and [symbol] , each of which can be read aloud individually as a description of the character [symbol] .

Particular embodiments of the subject matter described in this specification can be implemented to realize the following advantages. Accessibility is provided to Chinese or Japanese speaking users who cannot use conventional computers with the same level of accessibility that users of other languages (e.g., English) enjoy.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an accessibility system for audibly presenting exemplary descriptions of homophones.

FIG. 2 is a block diagram of an exemplary software architecture for audibly presenting exemplar descriptions of homophones.

FIG. 3 is an exemplary process for audibly presenting exemplar descriptions of homophones.

FIG. 4 is a block diagram of an exemplary device architecture implementing the features and processes described in reference to FIGS. 1-3.

Like reference symbols in the various drawings indicate like elements.

### DETAILED DESCRIPTION

### Overview

In some implementations, a database of exemplar descriptions to be used to differentiate between homophones in Chinese and Japanese languages can be created manually for each character by a native speaker. In other implementations, a language dictionary containing frequency information can be used to locate the most frequently used multi-character word for a given character and an exemplar description for that character can be constructed using that word. If an exemplary description cannot be found manually or by using a language dictionary, an IDS can be used to construct a description of the character by splitting the character into its components (e.g., other characters), each of which can be read aloud as a description of the character. The exemplary description database can be pruned manually to remove errors or to assign more appropriate exemplar descriptions when available.

In some implementations, the exemplar descriptions can be used when the user is typing a character into an electronic device (e.g., typing into a computer or smart phone). For example, the user might want to type a specific Chinese character [symbol] (rain) with the sound ‘yu’ using a virtual keyboard of a computer, smart phone or electronic tablet. Using a Chinese Pinyin (Phonetic) keyboard, the user can input the word “yu,” resulting in display of a candidate list of homophones for “yu.” As the user cycles through the candidate homophones in the candidate list (all of which have the pronunciation “yu”) the user will hear an exemplar description for each homophone. The exemplary description allows the user to differentiate between the candidate homophones and select the desired candidate.

### Exemplary Chinese Typing Scenario

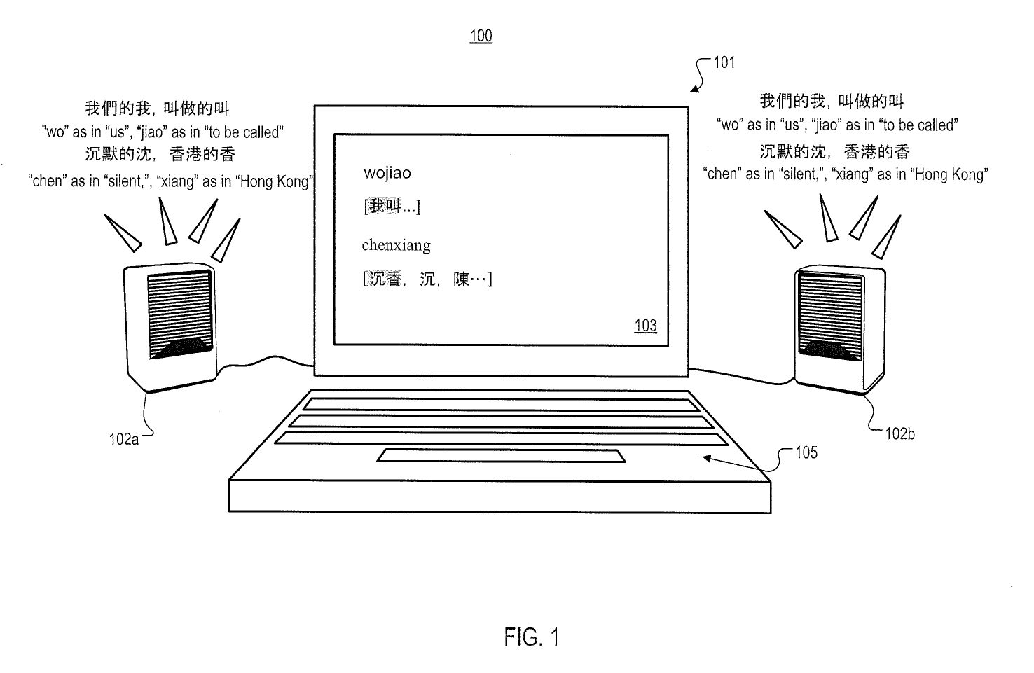

FIG. 1 illustrates an accessibility system 100 for audibly presenting exemplary descriptions of homophones. In some implementations, system 100 can include data processing apparatus 101 coupled to loudspeakers 102a, 102b. Data processing apparatus 101 can be a computer, electronic tablet, smart phone, television system, game console and any other device capable of converting text to speech. In some implementations, data processing apparatus 101 can include headphone speakers in addition or in place of loudspeakers 102a, 102b. Data processing apparatus 101 can include or couple to output device 103 (e.g., LED display) for displaying characters typed by a user with keyboard 105.

In this example Chinese typing scenario, the user wants to type “ [symbol] ” (“My name is Chen Xiang”), which is “Wo jiao Chen Xiang” in Romanization. The user types “wojiao,” resulting in the display of candidate characters “ [symbol] ” on output device 103. The candidate characters produce the exemplary descriptions “ [symbol] , [symbol] ,”(“‘wo’ as in ‘us’ and ‘jiao’ as in ‘to be called’”), which are read out through loudspeakers 102a, 102b. After hearing the exemplary descriptions, the user can confirm the desired candidate homophone by pressing a key on keyboard 105 (e.g., enter key) or by performing some other confirmatory action.

In another example, the user types “chenxiang,” resulting in the display of candidate characters [ [symbol] , [symbol] , [symbol] . . . ] on output device 103. In this scenario, the desired candidate character is not in the candidate list. The first character, however, is in the third position in the candidate list. Since “ [symbol] ” is the first candidate, its exemplary description “ [symbol] [symbol] , [symbol] ” (“‘chen” as in ‘silent,’, ‘xiang’ as in ‘Hong Kong’”) is read out of loudspeakers 102a, 102b. Hearing this, the user moves (e.g., by pressing a tab or arrow key on keyboard 105) to the next candidate “ [symbol] ”, resulting in its exemplary description “ [symbol] ”(“‘chen’ as in ‘silent’”) being read out of loudspeakers 102a, 102b. Again, the user determines that this is not the candidate homophone she wants and moves to the next candidate in the candidate list, which is “ [symbol] ”. The exemplary description “ [symbol] ” (“‘chen’ as in ‘to exhibit’) is then read out of loudspeakers 102a, 102b.

Based on the exemplary description, the user knows that this is the candidate homophone she is seeking and confirms it by pressing a key on keyboard 105 (e.g., enter key) or by performing some other confirmatory action. At this point, candidate homophones for “xiang” can be displayed to the user and the user can progress through the candidate list, listening to the exemplary description of each candidate homophone until the user arrives at “ [symbol] ,” which she confirms as the desired candidate homophone.

### Exemplary Japanese Typing Scenario

In an example Japanese typing scenario, the user wants to type “ [symbol] ” (“church,” which is “kyoukai” in Romanization). The user types “kyoukai” and “ [symbol] ” is the first candidate and the exemplary description “ [symbol] [symbol] ” (“‘kyou’ as in ‘association’, ‘kai’ as in ‘company’) is read out of loudspeakers 102a, 102b. Since this is not the candidate the user wants, she moves to the next candidate in the list (e.g., by pressing a tab/arrow key).

The next candidate is “ [symbol] ,” for which the description “ [symbol] [symbol] ”(“‘kyou’ as in ‘territory’, ‘kai’ as in ‘world’”) is read out of loudspeakers 102a, 102b. Again, this is not the candidate that the user wants, so she moves to the next candidate in the list. The next candidate is “ [symbol] ,” for which the exemplary description “ [symbol] [symbol] ” (“‘kyou’ as in ‘to teach’, ‘kai’ as in ‘company’”) is read out of loudspeakers 102a, 102b. Since this is the candidate that the user wants, she confirms the candidate by pressing a key on keyboard 105 or by performing some other confirmatory action.

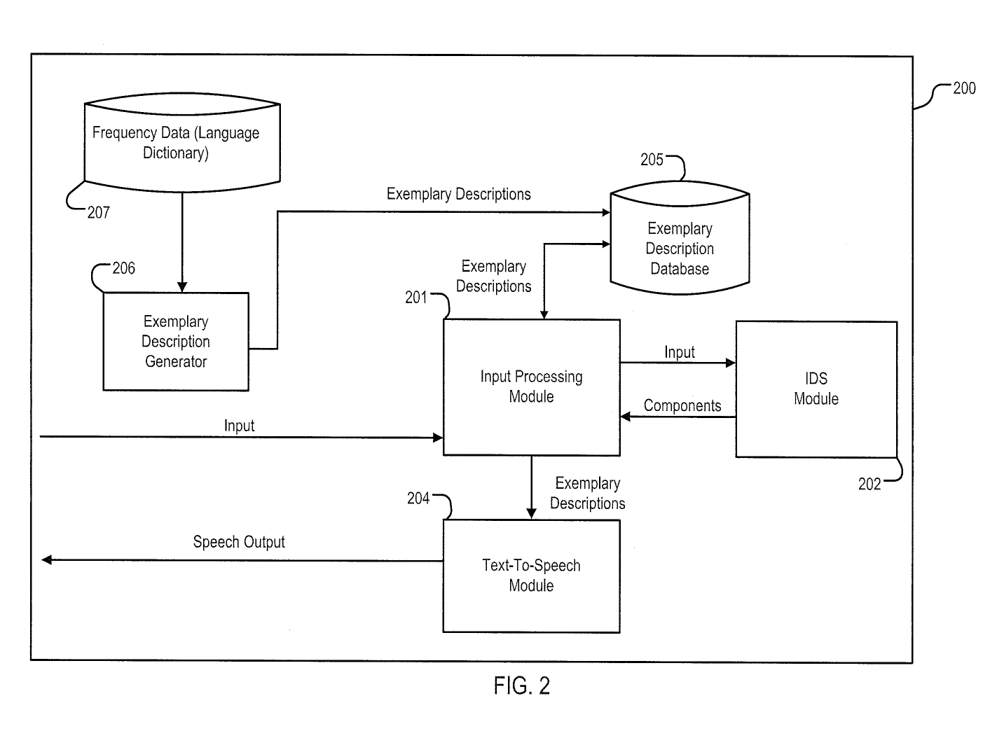

FIG. 2 is a block diagram of an exemplary software architecture 200 for audibly presenting exemplar descriptions of homophones. In some implementations, architecture 200 can include homophone identifier module 201, IDS module 202, text-to-speech 204, exemplary description database 205, exemplary description generator 206 and frequency data 207.

In operation, one or more characters are provided to input processing module 201. Characters can be Pinyin or Roman characters, for example. Module 201 can determine if an exemplary description is available for the one or more characters (e.g., a common Chinese character). In some implementations, the determining can include comparing the one or more characters with exemplary description database 205 to determine if an exemplary description is available for the one or more characters. If an exemplary description is available, the exemplary description can be provided to text-to-speech module 204, which can convert the text to speech output that can be audibly presented on a loudspeaker or headphones. Text-to-speech engine can use any known text-to-speech technology including but not limited to technologies for concatenative synthesis, formant synthesis, articulatory synthesis and HMM-based synthesis.

If an exemplary description is not available for the one or more characters (e.g., a rare Chinese character), input processing module 201 provides the input to IDS module 202. IDS module 202 splits the character into its components, which are sent back to input processing module 201. Input processing module 201 then sends a description of each component to text-to-speech module 204 to be converted to speech output. IDS data and algorithms are described in the publicly available Unicode standard version 6.0.

In some implementations, exemplary descriptions for each homophone character can be constructed manually by a native speaker and stored in exemplary description database 205. In other implementations, frequency database 207 can be used to construct exemplary descriptions. For example, a language dictionary may provide frequency data for determining the most frequently used multi-character words in the Chinese or Japanese language. Once the most frequently used multi-character words have been identified, exemplary descriptions can be constructed using the identified words. If an exemplar description is not found using this method, then an IDS can be used to determine a description for the homophone. The exemplary descriptions database 205 can be pruned (e.g., pruned manually) periodically to address errors or to assign more appropriate exemplary descriptions when available.

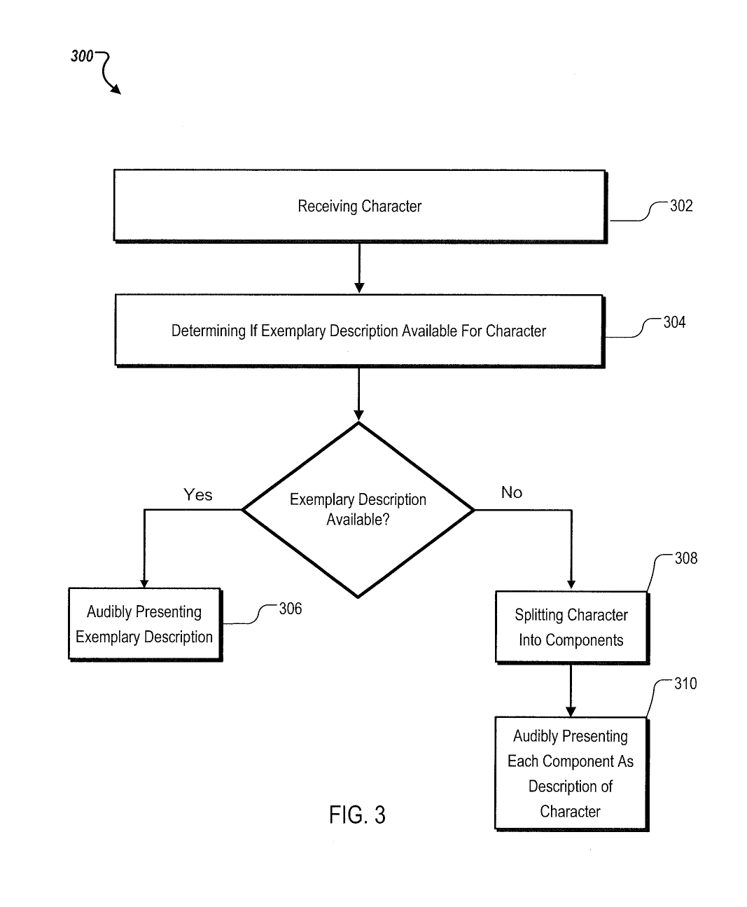

FIG. 3 is a flow diagram of an exemplary process 300 for audibly presenting exemplar descriptions of homophones. Process 300 can be implemented by software architecture 200.

In some implementations, process 300 can begin by receiving one or more characters (302). The one or more characters can be typed by a user using, for example, a keyboard. Characters can be Chinese or Japanese characters. Process 300 can continue by determining if an exemplary description of the character is available (304). For example, one or more characters can be compared against a database of exemplary descriptions to determine if an exemplary description is available for a character. If an exemplary description is available, the exemplary description can be audibly presented (306). For example, the exemplary description can be converted from text to speech output and audibly presented through a loudspeaker or headphones. If an exemplary description is not available, an IDS for the character can be used to split the character into components (308) and the components can then be audibly presented as a description of the character (310). For example, an IDS can split a character into multiple characters, each of which can be converted from text to speech output and audibly presented through a loudspeaker or headphones as a description of the homophone character.

### Exemplary Device Architecture

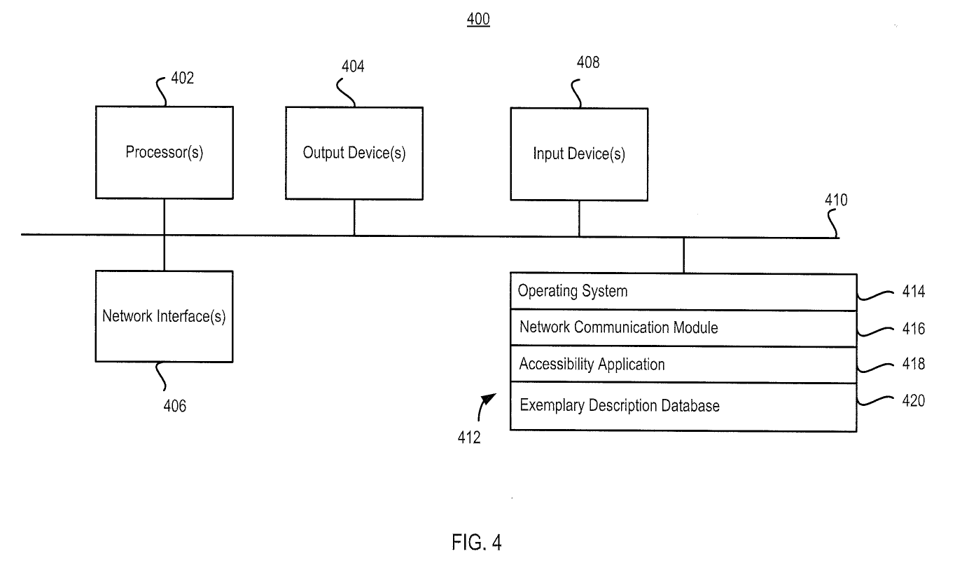

FIG. 4 is a block diagram illustrating exemplary device architecture implementing features and operations described in reference to FIGS. 1-3. Other architectures are possible, including architectures with more or fewer components. In some implementations, architecture 400 includes one or more processors 402 (e.g., dual-core Intel® Xeon® Processors), one or more output devices 404 (e.g., LCD), one or more network interfaces 406, one or more input devices 408 (e.g., mouse, keyboard, touch-sensitive display) and one or more computer-readable mediums 412 (e.g., RAM, ROM, SDRAM, hard disk, optical disk, flash memory, etc.). These components can exchange communications and data over one or more communication channels 410 (e.g., buses), which can utilize various hardware and software for facilitating the transfer of data and control signals between components.

The term “computer-readable medium” refers to a medium that participates in providing instructions to processor 402 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 412 can further include operating system 414 (e.g., a Linux® operating system), network communication module 416, accessibility application 418 and exemplary description database 420. Operating system 414 can be multi-user, multiprocessing, multitasking, multithreading, real time, etc. Operating system 414 performs basic tasks, including but not limited to: recognizing input from and providing output to devices 406, 408; keeping track and managing files and directories on computer-readable mediums 412 (e.g., memory or a storage device); controlling peripheral devices; and managing traffic on the one or more communication channels 410. Network communications module 416 includes various components for establishing and maintaining network connections (e.g., software for implementing communication protocols, such as TCP/IP, HTTP, etc.). Accessibility application 418, together with exemplary description database 420 can provide and perform the features and processes described in reference to FIGS. 1-3.

Architecture 400 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed implementations can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
receiving a character;
determining that an exemplary description of the character is available;
obtaining an exemplary description of the character; and
audibly presenting the exemplary description,
where the method is performed by one or more hardware processors.

2. The method of claim 1, where receiving the character further comprises:
receiving the character as keyboard input.

3. The method of claim 1, where determining that an exemplary description of the character is available includes comparing the character to an exemplary description database.

4. The method of claim 1, where the exemplary description is text and audibly presenting the exemplary description includes converting the exemplary description from text to speech.

5. The method of claim 4, where audibly presenting includes playing the speech through a loudspeaker or headphones.

6. The method of claim 1, where the exemplary description is constructed based on a frequency of use of the character.

7. The method of claim 1, where the character is a Chinese or Japanese character.

8. The method of claim 1, further comprising
determining that an exemplary description is not available;
splitting the character into components; and
audibly presenting each component as a description for the character.

9. The method of claim 8, where an Ideographic Description Sequence (IDS) is used to split the character into components.

10. A system comprising:
one or more processors;
memory coupled to the one or more processors and configured to store instructions, which, when executed by the one or more processors, causes the one or more processors to perform operations comprising:
receiving a character;
determining that an exemplary description of the character is available;
obtaining an exemplary description of the character; and
audibly presenting the exemplary description.

11. The system of claim 10, where receiving the character further comprises:
receiving the character as keyboard input.

12. The system of claim 10, where determining that an exemplary description of the character is available includes comparing the character to an exemplary description database.

13. The system of claim 10, where the exemplary description is text and audibly presenting the exemplary description includes converting the exemplary description from text to speech.

14. The system of claim 13, where audibly presenting includes playing the speech through a loudspeaker or headphones.

15. The system of claim 10, where the exemplary description is constructed based on a frequency of use of the character.

16. The system of claim 10, where the character is a Chinese or Japanese character.

17. The system of claim 10, where the one or more processors perform operations comprising:
determining that an exemplary description is not available;
splitting the character into components; and
audibly presenting each component as a description for the character.

18. The system of claim 17, where an Ideographic Description Sequence (IDS) is used to split the character into components.

19. A system comprising:
means for receiving a character;
means for determining that an exemplary description of the character is available;
means for obtaining an exemplary description of the character; and
means for audibly presenting the exemplary description.

20. The system of claim 19, where the exemplary description is constructed based on a frequency of use of the character.
